(19) United States
(12) Patent Application Publication
(10) Pub. No.: US 2024/0256781 A1
(43) Pub. Date: Aug. 1, 2024

(54) SYSTEM AND METHOD FOR ELECTRONICALLY DETERMINING SEMANTIC RELATIONSHIP IN DATA ITEMS

(71) Applicant: Innoplexus AG, Eschborn (DE)

(72) Inventors: Oliver Pfante, Frankfurt am Main (DE); Juan-Pablo Vesga-Simmons, Frankfurt am Main (DE)

(73) Assignee: Innoplexus AG, Eschborn (DE)

(21) Appl. No.: 18/162,830

(22) Filed: Feb. 1, 2023

(51) Int. Cl. G06F 40/30; G06F 40/117; G06F 40/154; G06F 40/169; G06F 40/211; G06F 40/295

(52) U.S. Cl. CPC G06F 40/30; G06F 40/117; G06F 40/154; G06F 40/169; G06F 40/211; G06F 40/295

(57) ABSTRACT

A method for electronically determining semantic relationship in data items includes extracting an entity and trigger terms associated with the entity from a sentence in the data items associated with a candidate identifier. The method further includes parsing the sentence in the data items to generate a parse tree. The method further includes identifying a node with a specific syntactic function associated with a candidate trigger term in the parse tree. The method further includes executing a search for the entity in the subtree originating at the identified node of the parse tree and then annotating context of the entity based on a presence of the entity in the subtree. The annotated context of the entity is used for determining semantic relationship in the data items to enable context-based search.

### FIELD OF TECHNOLOGY

The present disclosure relates generally to electronically determining semantic relationship in data items, and more specifically, to a system and a method of electronically determining semantic relationship in data items.

### BACKGROUND

In different fields, such as medical trials, legal proceedings, marketing analysis, and the like, one or more documents associated with candidates may be used for various objectives. For example, in medical and bioinformatics industry, medical reports are generally used to identify candidates whose conditions are more likely to match the eligibility criteria of a medical or clinical trial. Such conditions could be based on diagnosis or indications mentioned in the medical reports associated with the candidates. Conventionally, the process of evaluating the candidates for the medical or clinical trial depends on identification of biomedical entities in the medical reports and then understanding context of the biomedical entities in the medical reports based on the identification of the biomedical entities. In the medical technology and bioinformatics industry, biomedical entities may refer to a person, object, or concept that is related to the field of biomedicine. However, the mere presence of a certain diagnosis, treatment, or biomedical entity in the medical reports may not be sufficient to understand the context of the biomedical entities in the medical reports. In general, for understanding correct context of each document, it is important to understand semantics of sentences which contain one or more target entities in each document. Without understanding the semantics of the sentences in the documents, confusion may occur while understanding the correct context of the entities in the documents which may further result in incorrect conclusions, misinterpretations, and poor decision-making.

In some scenarios, rule-based algorithms may be used to provide a better understanding of the context of the entities in the documents by inferring possible negation or affirmation of the target entity present in the document. However, such approach may have a low precision. In some other scenarios, AI-based algorithms may be used to provide a better understanding of the context of the entities in the documents by working exclusively with machine learning models. However, such approaches may require working with multiple entity-classes and huge models that may demand a lot of training data. Thus, there is a technical problem of electronically determining semantic relationship in one or more data items and accurately understanding the context of entities in the one or more data items.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a system and a method for electronically determining semantic relationship in one or more data items. The present disclosure seeks to provide a solution to the existing problem of electronically determining semantic relationship in the one or more data items and accurately understanding the context of entities in the one or more data items. An aim of the present disclosure is to provide a solution that overcomes at least partially the problems encountered in prior art and provide an improved system and method for electronically determining the semantic relationship in the one or more data items in a way such that the correct understanding of the context of the sentences in the data items may be achieved and based on the correct understanding of the context.

In one aspect, the present disclosure provides a method for electronically determining semantic relationship in one or more data items, the method comprising:
extracting, by the processor, an entity and one or more trigger terms associated with the entity from at least one sentence in the one or more data items, wherein the one or more data items are associated with a candidate identifier;
parsing, by the processor, the at least one sentence in the one or more data items to generate a parse tree, wherein the parse tree comprises one or more nodes, each node having a specific syntactic functions;
identifying, by the processor, a node of the one or more nodes with a specific syntactic function associated with a candidate trigger term of the one or more trigger terms in the parse tree, wherein the identified node with the specific syntactic function comprises each element of the candidate trigger term;
executing, by the processor, a search for the entity in a subtree originated at the identified node of the parse tree; and
annotating, by the processor, context of the entity based on a presence of the entity in the subtree originated at the identified node of the parse tree, wherein the annotated context of the entity is used for determining semantic relationship in the data items to enable context-based search.

The method may provide a more accurate and efficient way for annotating context of the entities in the data items associated with the plurality of candidate identifiers. The method may further help to improve the efficiency and effectiveness of the various industries and fields by solving different objectives, such as medical or clinical trials, analysis, etc., more accurately and reliably. The method may further help to efficiently determining semantic relationship in the data items to enable context-based search.

In another aspect, the present disclosure provides a system for electronically determining semantic relationship in one or more data items, the system comprising:
a memory comprising the one or more data items; and
a processor communicatively coupled to the memory, wherein the processor is configured to:
   extract an entity and one or more trigger terms associated with the entity from at least one sentence in the one or more data items, wherein the one or more data items are associated with a candidate identifier;
   parse the at least one sentence in the one or more data items to generate a parse tree;
   identify a node with a specific syntactic function associated with a candidate trigger term of the one or more trigger terms in the parse tree, wherein the identified node with the specific syntactic function comprises each element of the candidate trigger term;
   execute a search for the entity in a subtree originated at the identified node of the parse tree; and
   annotate context of the entity based on a presence of the entity in the subtree originated at the identified node of the parse tree, wherein the annotated context of the entity is used for determining semantic relationship in the data items to enable context-based search.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for electronically determining a semantic relationship in one or more data items, in accordance with an embodiment of the present disclosure;

FIG. 2 is a block diagram of another system for electronically determining the semantic relationship in the one or more data items, in accordance with an embodiment of the present disclosure;

FIG. 3 is a flowchart for electronically determining a semantic relationship in the one or more data items, in accordance with an embodiment of the present disclosure; and

FIG. 4 is a flowchart of a method for electronically determining the semantic relationship in the one or more data items, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

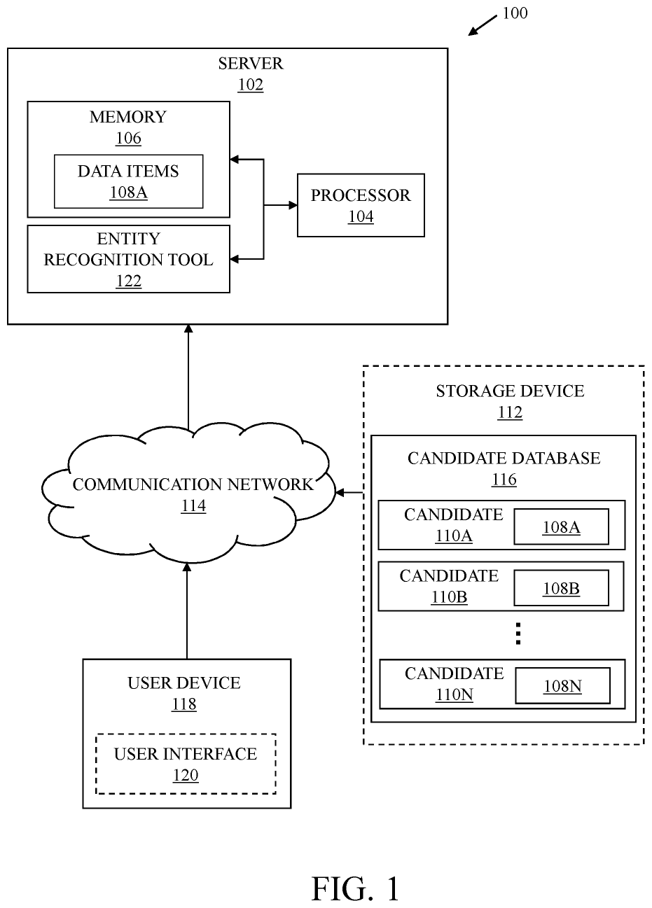

FIG. 1 is a block diagram of a system for electronically determining semantic relationship in one or more data items, in accordance with an embodiment of the present disclosure. With reference to FIG. 1, there is shown a block diagram of a system 100. The system 100 includes a server 102, a processor 104, and a memory 106. The memory 106 includes one or more data items, for example, one or more data items 108A. The one or more data items 108A are associated with a candidate identifier 110A.

It should be noted that the system 100 is explained by taking an example of the medical field where eligible candidates are to be selected for medical or clinical trials based on the context of the one or more data items associated with candidates. However, the system 200 is equally applicable to other applications of various fields such as legal proceedings, marketing analysis, finance analysis, and any other field where there is a need of accurately understanding the context of the one or more data items 108A to 108N. For example, the system 200 may determine semantic relationship in given documents to enable context-based search. This may allow for a more precise identification of relevant information within the given documents.

In an implementation, the processor 104 and the memory 106 may be implemented on a same server, such as the server 102. In some implementations, the system 100 further includes a storage device 112 communicatively coupled to the server 102 via a communication network 114. The storage device 112 includes a candidate database 116 of a plurality of candidates having a candidate identifier 110A to 110N for the medical or clinical trial, and the one or more data items 108A to 108N associated with the plurality of candidate identifiers 110A to 10N. In some implementations, the one or more data items 108A to 108N associated with each candidate identifier of the plurality of candidate identifiers 110A to 110N may be retrieved from the storage device 112 by the memory 106, as per requirement. In some implementations, the candidate database 116 may be stored in the same server, such as the server 102. In some other implementations, the candidate database 116 may be stored outside the server 102, as shown in FIG. 1. The server 102 may be communicatively coupled to a plurality of user devices, such as a user device 118, via the communication network 114. The user device 118 includes a user interface 120.

The present disclosure provides the system 100 that electronically determines the semantic relationship in the one or more data items 108A to 108N for the medical or clinical application, where the system 100 identify an entity from at least one sentence in the one or more data items 108A to 108N and then annotate context of the entity to identify one or more eligible candidate identifiers from the plurality of candidate identifiers 110A to 110N for a given medical or clinical trial. The entity may be a biomedical entity referring to a person, object, or concept that is related to the field of biomedicine. The entity may include living organisms, such as humans, animals, and plants, as well as non-living entities, such as genes, proteins, and diseases. In biomedical research, such entities are studied in order to understand how they function and interact with one another, and to develop new treatments and therapies for various medical conditions. The medical or clinical trial refers to research studies performed in people that are aimed at evaluating a medical, surgical, or behavioral intervention.

The server 102 includes suitable logic, circuitry, interfaces, and code that may be configured to communicate with the user device 118 via the communication network 114. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. The memory 106 is configured to store the one or more data items 108A to 108N. Furthermore, a single memory may encompass and, in a scenario, and the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The storage device 112 may be any storage device that stores data and applications without any limitation thereto. In an implementation, the storage device 112 may be a cloud storage, or an array of storage devices.

The communication network 114 includes a medium (e.g., a communication channel) through which the user device 118 communicates with the server 102. The communication network 114 may be a wired or wireless communication network. Examples of the communication network 114 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The user device 118 refers to an electronic computing device operated by a user. The user device 118 may be configured to obtain a user input of one or more words in a search portal or a search engine rendered over the user interface 120 and communicate the user input to the server 102. The server 102 may then be configured to retrieve a candidate identifier that represents a candidate whose one or more data items relate to the user input of the one or more words. Examples of the user device 118 may include but not limited to a mobile device, a smartphone, a desktop computer, a laptop computer, a Chromebook, a tablet computer, a robotic device, or other user devices.

In accordance with an embodiment, each data item of the one or more data items 108A to 108N may include, but not limited to, unstructured text, reports, charts, records, journals, and the like, related to a candidate. In some examples, each data item of the one or more data items 108A to 108N may include multiple sentences containing a candidate's history, physical examination, diagnoses, finance plans, and other relevant details.

It should be understood by one of ordinary skills in the art that the operations of the system 100 are explained by using the one or more data items 108A associated with the candidate identifier 110A. However, the operation of the system 100 is equally applicable for the one or more data items 108A to 108N associated with the candidate identifier 110A to 110N.

In operation, the processor 104 is configured to extract the entity and one or more trigger terms associated with the entity from at least one sentence in the one or more data items 108A. The trigger terms refer to a word or phrase that is used to initiate a specific action or response. In some implementations, the extracting of the entity and the one or more trigger terms associated with the entity includes executing, by the processor 104, an entity recognition tool 122 to recognize the entity. The entity recognition tool 122 refers to a software application that is designed to identify and classify named entities in a piece of text. Some examples of named entities are specific people, organizations, locations, dates, and other types of information that can be extracted from a text. The entity recognition tool 122 is commonly used in natural language processing (NLP) tasks, such as information extraction, machine translation, and question answering. In an example, for an exemplary sentence, “The patient shows no symptoms of Hepatitis-A in the last three months,” an extracted entity is “Hepatitis-A”.

In some implementations, the extraction of the entity and the one or more trigger terms associated with the entity further includes identifying, by the processor 104, the one or more trigger terms associated with the entity. Specifically, the identification of the one or more trigger terms associated with the entity may include identifying the verbs or other keywords that are related to the entity. By using the above example, in the exemplary sentence, two trigger terms associated with the entity, “Hepatitis-A,” have been identified, i.e., a first trigger term, “no symptoms of,” and a second trigger term, “in the last three months.” The first trigger term, “no symptoms of,” specifies the existence of the entity, while the second trigger term, “in the last three months,” specifies the temporality of the entity. In this case, the first trigger term indicates that the entity, “Hepatitis-A,” may not be present or may no longer exist in the patient. Furthermore, the second trigger term specifies the temporality of the entity. In this case, the second trigger term indicates that a time frame in which the entity (in this case, Hepatitis-A) exists or is relevant.

It should be noted that the one or more trigger terms associated with the entity may be crucial for accurately interpreting the meaning of the entity. Also, the specific trigger terms and their meanings may change the context of the sentence and the entity being extracted.

The processor 104 is further configured to assign default values to the entity from a predefined set of default values post extraction of the entity based on one or more relational properties of the entity. The one or more relational properties of the entity include an addendum property and a temporality property. The one or more relational properties of the entity may include any other relational property, without any limitation. The predefined set of default values includes an addendum default value for the addendum property indicating a condition of the entity tagged as “certain” and a temporal default value for the temporality property indicating a temporal relation of the entity tagged as “recent”. In detail, the addendum property refers to a property that may be used to tag an entity with additional information or context. The addendum default value for the addendum property indicates a condition of the entity that has been tagged with the addendum property. In this case, the default value indicates that the condition of the entity is “certain”, thereby implying that the condition is known to be true or reliable. The temporality property refers to a property that may be used to tag the entity with information about its temporal relation, or its relation to time. The temporal default value for the temporality property indicates a temporal relation of the entity that has been tagged with the temporality property. In this case, the default value indicates that the temporal relation of the entity is recent, thereby implying that the entity has a close or current connection to the present time. In an example, for the exemplary sentence, “The patient shows no symptoms of Hepatitis-A in the last three months,” the addendum default value and the temporal default value of the entity (in this case, Hepatitis-A) are “certain” and “recent”, respectively.

The processor 104 is further configured to parse the at least one sentence in the one or more data items 108A to generate a parse tree. A parse tree may also be known as a syntax tree or a derivation tree. The parse tree refers to a graphical representation of the syntactic structure of a sentence in a natural language. The parse tree may show relationships between words and phrases in the sentence, and how they are connected to form a meaning of the sentence.

In an implementation, the parse tree includes one or more nodes having one or more syntactic functions. Specifically, in the parse tree, the one or more nodes may represent words or phrases in the sentence, and the one or more nodes have different syntactic functions. The syntactic functions refer to the roles that words or phrases play in the structure of a sentence. Some common syntactic functions may include subject, verb, object, modifier, and complement.

Parsing the at least one sentence may include analyzing a syntactic structure of the sentence and identifying the relationships between the words and phrases in the sentence. In some examples, to parse a sentence and generate a parse tree, the NLP techniques such as dependency parsing or constituency parsing may be used. The dependency parsing involves analyzing dependencies between the words in a sentence and then representing the words as directed arcs in a tree-like structure. The constituency parsing involves analyzing a hierarchical structure of the sentence and then representing the hierarchical structure as a tree-like structure.

The processor 104 is further configured to identify a node with a specific syntactic function associated with a candidate trigger term of the one or more trigger terms in the parse tree. The identification of the node with the specific syntactic function associated with the candidate trigger term in the parse tree includes executing a search along the parse tree to obtain the candidate trigger term. In some examples, searching along the parse tree may include scanning the parse tree for the candidate trigger term. In some other examples, the searching along the parse tree may involve using a search operation to look for the candidate trigger term.

Further, the identifying of the node with the specific syntactic function associated with the candidate trigger term in the parse tree includes traversing the one or more nodes of the parse tree in a defined direction from the candidate trigger term to obtain the node with the specific syntactic function associated with the candidate trigger term. In other words, branches or edges of the parse tree may be followed in a specific order, such as from left to right or from root to leaf. The defined direction and order of traversal may depend on syntax and structure of the natural language being used, as well as the specific syntactic function that is being sought.

The identified node with the specific syntactic function includes each element of the candidate trigger term. In an example, for an exemplary candidate trigger term, “no symptoms of,” an identified node with a specific syntactic function includes each element, such as “no,” “symptoms,” and “of,” of the exemplary candidate trigger term.

The processor 104 is further configured to execute a search for the entity in a subtree originated at the identified node of the parse tree. The subtree refers to a portion of the parse tree that is rooted at a specific node and includes all of the nodes and branches that are descended from the specific node. In some examples, the searching along the parse tree may again involve using the search operation to look for the entity in the subtree originated at the identified node of the parse tree.

The processor 104 is further configured to modify the assigned default values of the entity based on a meaning of the candidate trigger term when the entity is detected in the subtree originated at the identified node of the parse tree. The modification of the assigned default values of the entity based on the meaning of the candidate trigger term includes determining modified values to be assigned to the entity from a plurality of modified values based on the meaning of the candidate trigger term, and then assigning the modified values to the entity. It should be noted that the modified values of the entity are determined for each of the addendum property and the temporality property. The modified values of the entity for the addendum property may include “excluded” or “suspected” based on the meaning of the candidate trigger term. The modified values of the entity for the temporality property may include numerical based values or rule-based values. In an implementation, the plurality of modified values indicates whether the entity associated with the candidate is to be tagged as “excluded” or to be tagged as “suspected”, and whether the entity associated with the candidate is to be tagged with the numerical based values or the rule-based values.

In an example, for the exemplary sentence “The patient shows no symptoms of Hepatitis-A in the last three months,” the entity (Hepatitis-A) is associated with the trigger terms “no symptoms of” and “in the last three months,” which specify the condition and temporality of the entity, respectively. The trigger terms indicate that the entity (Hepatitis-A) may not be present or may no longer exist, and that it has not been relevant in the recent past. As discussed above, the assigned default values for the entity (Hepatitis-A) are “certain” and “recent.” After modification, the assigned default value of the entity for the addendum property is modified from “certain” to “excluded” based on the meaning of the candidate trigger term “no symptom of.” The modified value, “excluded,” indicates that the entity (Hepatitis-A) may not be present or may no longer exist. Further, after modification, the assigned default value of the entity for the temporality property is modified from “recent” to “3M” based on the meaning of the candidate trigger term “in the last three months.” The modified value “3M” is a standardized value for a three months' time period and indicates the entity is not present for the past three months.

However, in some cases, the modification of the assigned default values of the entity may not be needed. In an example, for an exemplary sentence “The patient has been diagnosed with Hepatitis-A,” the entity (Hepatitis-A) is associated with the trigger term “diagnosed with,” which specifies the existence and condition of the entity. In this example, meaning of the trigger term “diagnosed with” may indicate that the entity is present and has been formally identified or confirmed, and the addendum property of the entity may be left unchanged at “certain.”

The processor 104 is further configured to annotate context of the entity based on a presence of the entity in the subtree originated at the identified node of the parse tree. In an implementation, the annotating of the context of the entity is based on the modified values of the entity. The annotating of the context of the entity may include adding additional information or metadata to the entity to provide a more complete understanding of meaning and significance of the entity. Moreover, by annotating the context of the entity, an accurate and precise understanding of the context of the sentence may be achieved.

In an implementation, the annotated context of the entity may be used to establish eligibility or ineligibility of the candidate with the candidate identifier for the given medical or clinical trial in accordance with an eligibility criterion of the given medical or clinical trial. In some examples, the eligibility or ineligibility of the candidate for the given clinical trial may be established by the matching the annotated context of the entity with the eligibility criterion of the given clinical trial.

In some cases, when the candidate trigger term extracted from the at least one sentence is a part of a phrase, the processor 104 is further configured to execute a search in the subtree originated at the identified node of the parse tree to obtain a nested trigger term. Further, the processor 104 is configured to re-modify the modified values of the entity to the default value of the entity based on a presence of the nested trigger term in the subtree originated at the identified node of the parse tree. The nested trigger term refers to a trigger term that is embedded within another trigger term or entity. The nested trigger term may have an inner trigger term and an outer trigger term that are nested together. In an example, for an exemplary sentence “Examination does not rule out the presence of cancer,” the nested trigger term is “does not rule out,” the meaning of the outer trigger term “does not” modifies the meaning of the inner trigger term “rule out.” In this example, the nested trigger term, “does not rule out,” indicates that the entity being referred to is not definitively excluded.

In some cases, when the entity is not detected in the subtree originated at the identified node of the parse tree post executing the search for the entity, the processor 104 is further configured to identify a next node with a specific syntactic function associated with a next candidate trigger term in the parse tree, execute another search for the entity in a subtree originated at the next identified node of the parse tree, modify the assigned default values of the entity based on meaning of the next candidate trigger term, and annotate the context of the entity based on modified values of the entity. It should be noted that the modification of the assigned default values of the entity and annotation of the context of the entity may happen when the entity is detected in the subtree originated at the next identified node of the parse tree. Still, if the entity is not detected in the subtree originated at the next identified node of the parse tree, the processor 104 is further configured to repeat process until the processor 104 detects the entity in the subtree originated at an identified node of the parse tree.

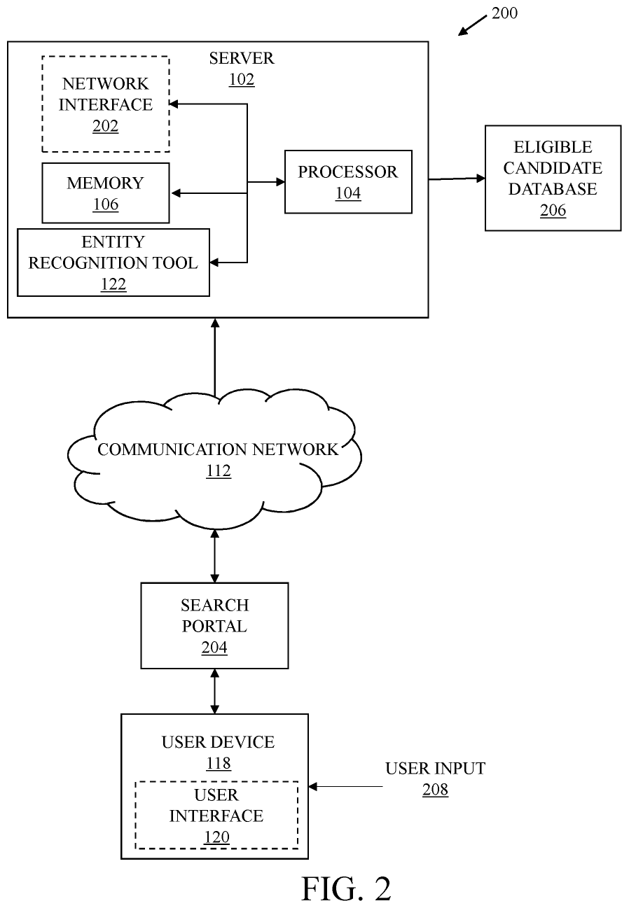

FIG. 2 is a block diagram of another system for electronically determining the semantic relationship in the one or more data items, in accordance with an embodiment of the present disclosure. FIG. 2 is described in conjunction with elements from FIG. 1. With reference to FIG. 2, there is shown a block diagram of a system 200 that includes the server 102, the processor 104 and the memory 106. The system 200 may be used to evaluate the eligible candidates for the medical or clinical application.

It should be noted that the system 200 and operation of the system 200 are explained by taking an example of the medical field where eligible candidates are to be selected for medical or clinical trials based on the context of the one or more data items 108A to 108N associated with candidates. However, the system 200 is equally applicable to other applications of various fields such as legal proceedings, marketing analysis, finance analysis, and any other field where there is a need of accurately understanding the context of the one or more data items 108A to 108N. For example, the system 200 may determine semantic relationship in given documents to enable context-based search. This may allow for a more precise identification of relevant information within the given documents.

The server 102 includes the processor 104 and the memory 106. The server 102 may further include a network interface 202. The network interface 202 is configured to communicate with the processor 104 and the memory 106. The system 200 further includes a search portal 204 communicatively connected to the server 102 and accessible by the user device 118, via the user interface 120 rendered on the user device 118. The system 200 further includes an eligible candidate database (ECD) 206 communicatively connected to the server 102. In an implementation, the ECD 206 may be stored in the server 102. In some other implementations, the ECD 206 may be stored outside the server 102, as shown in the system 200. The ECD 206 may include the candidate identifiers of the one or more eligible candidates which are eligible for the one or more given clinical trials in accordance with the eligibility criteria of the one or more given clinical trials.

The network interface 202 refers to a communication interface to enable communication of the server 102 to any other external device, such as the user device 118. Examples of the network interface 202 include, but are not limited to, a network interface card, a transceiver, and the like.

The search portal 204 refers to a search platform to enable a user to carry out web searches. The search portal 204 uses the candidate identifiers of the one or more eligible candidates identified by the system 200 stored as metadata to improve search and retrieval capability.

The ECD 206 refers to a collection of candidate identifiers of the one or more eligible candidates. The one or more eligible candidates are eligible for the one or more given clinical trials in accordance with the eligibility criteria of the one or more given clinical trials.

In operations, the processor 104 is further configured to form the ECD 206 of the one or more eligible candidates which are eligible for the one or more given medical or clinical trials in accordance with the eligibility criteria of the one or more given medical or clinical trials based on the annotated context of the entity retrieved from the one or more data items associated with a plurality of candidate identifiers. In other words, the ECD 206 includes a list of the one or more eligible candidates who meet the eligibility criteria for the one or more specific medical or clinical trials. The one or more eligible candidates may be selected by analyzing the annotated context of each candidate, which is retrieved from a variety of data items associated with their respective candidate identifiers. The ECD 206 may be used to identify suitable candidates for participation in the clinical trials, based on the eligibility requirements of each trial.

The processor 104 is further configured to receive a user input 208 of one or more words related to the eligibility criterion of the given clinical trial in the search portal 204. The user input 208 is received by the processor 108 in the search portal 204 via the user device 118. In an example, the user input 208 is received via the user interface 120 rendered on the user device 118. The processor 104 is further configured to retrieve the candidate identifier 110A having the one or more data items 108A related to the one or more words based on the annotated context of the entity retrieved from the one or more data items 108A.

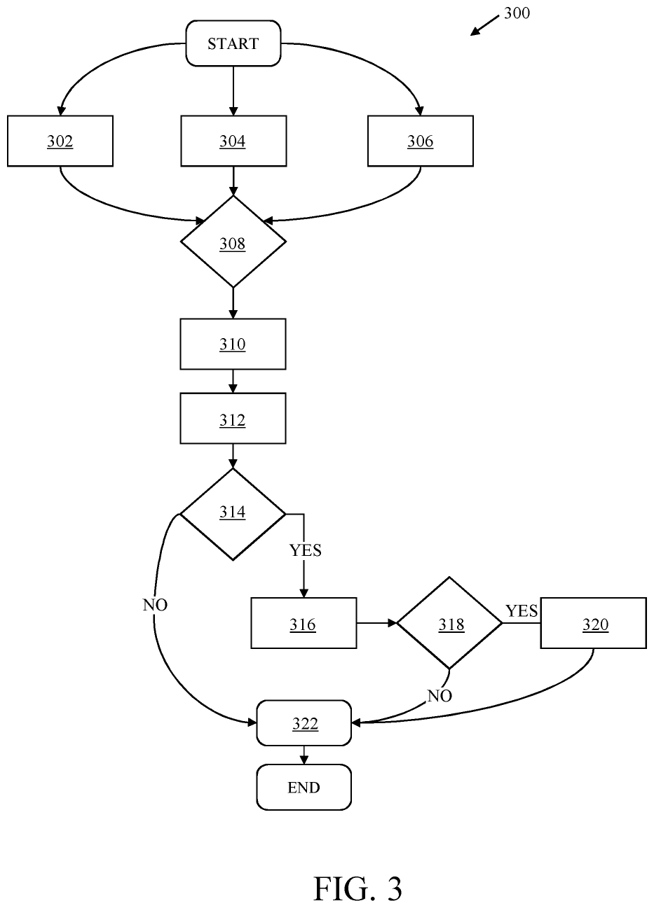

FIG. 3 depicts a flowchart for electronically determining the semantic relationship in the one or more data items, in accordance with an embodiment of the present disclosure. FIG. 3 is described in conjunction with elements from FIGS. 1 and 2. With reference to FIG. 3, there is shown a flowchart 300 that includes a series of operations from 302-to-322. The processor 104 (of FIG. 1) is configured to execute the flowchart 300.

At operation 302, the processor 104 is configured to execute the entity recognition tool 122 to extract the entities from the at least one sentence in the one or more data items 108A. Thereafter, at operation 304, the processor 104 is further configured to execute the entity recognition tool 122 to extract the one or more trigger terms that indicate the addendum property and the temporality property of the entity. After that, at operation 306, the processor 104 is further configured to generate the parse tree of the sentence using the constituency parsing. Furthermore, at operation 308, the processor 104 is further configured to collect the extracted entities and the one or more trigger terms associated with the extracted entities. After that, at operations 310, the processor 104 is further configured to identify the node with the specific syntactic function from the one or more nodes in the generated parse tree. The identified node with the specific syntactic function may be associated with the candidate trigger term of the one or more trigger terms and may include each element of the candidate trigger term. Furthermore, at operation 312, the processor 104 is further configured to execute a search for the entity in the subtree originated at the node identified at the operation 310. In addition, at operation 314, the processor 104 is further configured to check whether the subtree originated at the identified node of the parse tree includes the entity. Further, if the subtree originated at the identified node of the parse tree includes the entity, the process may reach operation 316. At the operation 316, the processor 104 is further configured to annotate the context of the entity. In some examples, the processor 104 is further configured to utilize the annotated context of the entity to establish eligibility or ineligibility of the candidate with the candidate identifier for the given medical or clinical trial in accordance with the eligibility criterion of the given medical or clinical trial. After that, at operation 318, the processor 104 is further configured to check whether the candidate trigger term extracted from the sentence at the operation 304 includes pseudo negations. The pseudo negation refers to a word or phrase that appears to negate or contradict the meaning of a sentence or phrase. Some examples of the pseudo negation may include “no,” “not,” and the like. If the candidate trigger term includes the pseudo negations, the process may reach operation 320. At the operation 320, the processor 104 is further configured to remove previously annotated context of the entity. After that, at operation 322, the processor 104 is further configured to repeat process depicted in the flowchart 300 for the next candidate trigger term. Furthermore, if any one of the checks fail at the operations 314 and 318, the process may reach the operation 322, where the process depicted in the flowchart 300 will be repeated for the next candidate trigger term.

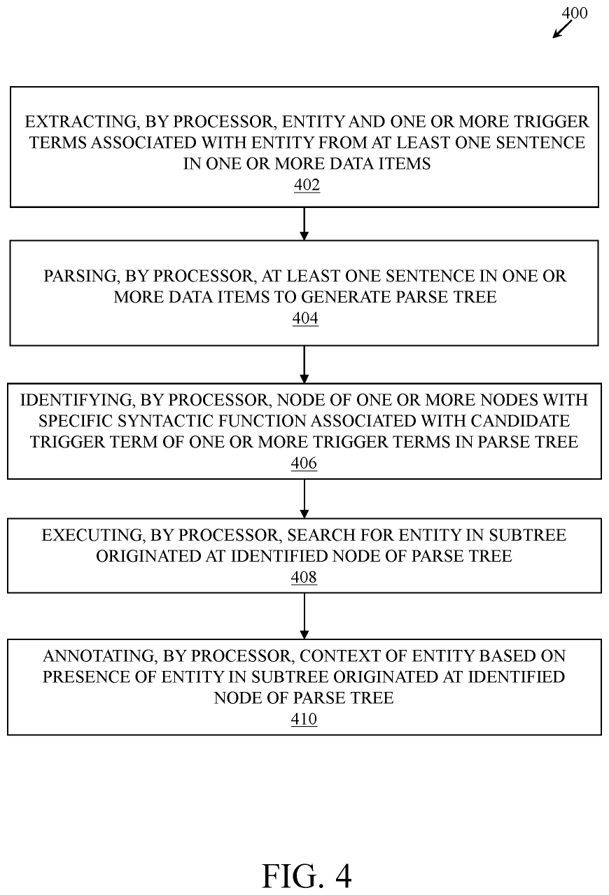

FIG. 4 is a flowchart of a method for electronically determining the semantic relationship in the one or more data items, in accordance with an embodiment of the present disclosure. FIG. 4 is explained in conjunction with elements from FIGS. 1, 2, and 3. With reference FIG. 4, there is shown a flowchart of a method 400. The method 400 is executed at the server 102 (of FIG. 1). The method 400 may include steps 402 to 410.

At step 402, the method 400 includes extracting, by the processor 104, the entity and the one or more trigger terms associated with the entity from the at least one sentence in the one or more data items 108A. The one or more data items 108A are associated with the candidate identifier 110A. The extracting of the entity and the one or more trigger terms at an initial step may facilitate easy determination of the context of the at least one sentence in the one or more data items 108A.

At step 404, the method 400 further includes parsing, by the processor 104, the at least one sentence in the one or more data items 108A to generate the parse tree. The parse tree includes the one or more nodes having the one or more syntactic functions. Parsing the at least one sentence to obtain the parse tree of the sentence may provide an improved understanding of the at least one sentence in the one or more data items 108A by representing the grammatical structure of the at least one sentence in a hierarchical manner.

At step 406, the method 400 further includes identifying, by the processor 104, the node of the one or more nodes with the specific syntactic function associated with the candidate trigger term of the one or more trigger terms in the parse tree. The identified node with the specific syntactic function includes each element of the candidate trigger term. Advantageously, the identification of the node with the specific syntactic function may also clarify the grammatical role and meaning of the words and phrases in the at least one sentence.

At step 408, the method 400 further includes executing, by the processor 104, the search for the entity in the subtree originated at the identified node of the parse tree. It should be noted that by focusing the search on a specific part of the parse tree, i.e., the subtree originated at the identified node of the parse tree, a deeper understanding of the context of the entity may be achieved.

At step 410, the method 400 further includes annotating, by the processor, the context of the entity based on a presence of the entity in the subtree originated at the identified node of the parse tree. The annotated context of the entity is used for determining semantic relationship in the data items 108A to 108N to enable the context-based search. In accordance with an embodiment, the method 400 further includes utilizing the annotated context of the entity to establish eligibility or ineligibility of the candidate with the candidate identifier for the given medical or clinical trial in accordance with the eligibility criterion of the given medical or clinical trial. The annotated context of the entity may facilitate accurate evaluation of the candidates for the medical or clinical trials. Moreover, it may also reduce the risk of incorrect evaluations and improve the overall efficiency of the process.

In accordance with an embodiment, the method 400 further includes assigning, by the processor 104, the default values to the entity from the predefined set of default values post extraction of the entity based on the one or more relational properties of the entity. The one or more relational properties of the entity include the addendum property and the temporality property.

In accordance with an embodiment, the method 400 further includes modifying, by the processor 104, the assigned default values of the entity based on the meaning of the candidate trigger term when the entity is detected in the subtree originated at the identified node of the parse tree.

In accordance with an embodiment, the method 400 further includes executing, by the processor 104, the search in the subtree originated at the identified node of the parse tree to obtain the nested trigger term, and then re-modifying, by the processor 104, the modified values of the entity to the default values of the entity based on a presence of the nested trigger term in the subtree originated at the identified node of the parse tree.

In accordance with an embodiment, the method 400 further includes forming, by the processor 104, the ECD 206 of the one or more candidates which are eligible for the one or more given medical or clinical trials in accordance with the eligibility criteria of the one or more given medical or clinical trials based on the annotated context of the entity retrieved from the one or more data items 108A to 108N associated with the plurality of candidate identifiers 110A to 110N.

In accordance with an embodiment, the method 400 further includes receiving, by the processor 104, the user input 208 of the one or more words related to the eligibility criteria of the given medical or clinical trial in the search portal 204, and then retrieving, by the processor 104, the candidate identifiers having the one or more data items related to the one or more words based on the annotated context of the entity retrieved from the one or more data items 108A to 108N.

In accordance with an embodiment, when the entity is not detected in the subtree originated at the identified node of the parse tree post executing the search for the entity, the method 400 further includes identifying, by the processor 100, the next node with the specific syntactic function associated with the next candidate trigger term in the parse tree. The method 400 further includes executing, by the processor 104, the search for the entity in a subtree originated at the next identified node of the parse tree. The method 400 further includes modifying, by the processor 104, the assigned default values of the entity based on meaning of the next candidate trigger term when the entity is detected in the subtree originated at the next identified node of the parse tree. The method 400 further includes annotating, by the processor 104, the context of the entity based on modified values of the entity.

The method 400 may provide a more accurate and efficient way for annotating context of the entities in the data items 108A to 108N associated with the plurality of candidate identifiers 110A to 110N. The method 400 may further help to improve the efficiency and effectiveness of the medical technology and bioinformatics industry by enabling more accurate and reliable evaluations of the candidates for the medical or clinical trials. The method 400 may further help to efficiently determining semantic relationship in the data items 108A to 108N to enable the context-based search.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method for electronically determining semantic relationship in one or more data items, the method comprising:
extracting, by the processor, an entity and one or more trigger terms associated with the entity from at least one sentence in the one or more data items, wherein the one or more data items are associated with a candidate identifier;
parsing, by the processor, the at least one sentence in the one or more data items to generate a parse tree, wherein the parse tree comprises one or more nodes, each node having a specific syntactic function;
identifying, by the processor, a node of the one or more nodes with a specific syntactic function associated with a candidate trigger term of the one or more trigger terms in the parse tree, wherein the identified node with the specific syntactic function comprises each element of the candidate trigger term;
executing, by the processor, a search for the entity in a subtree originated at the identified node of the parse tree; and
annotating, by the processor, context of the entity based on a presence of the entity in the subtree originated at the identified node of the parse tree, wherein the annotated context of the entity is used for determining semantic relationship in the data items to enable context-based search.

2. The method of claim 1, further comprising assigning, by the processor, default values to the entity from a predefined set of default values post extraction of the entity based on one or more relational properties of the entity, wherein the one or more relational properties of the entity comprise an addendum property and a temporality property.

3. The method of claim 2, wherein the predefined set of default values comprises an addendum default value for the addendum property indicating a condition of the entity tagged as certain and a temporal default value for the temporality property indicating a temporal relation of the entity tagged as recent.

4. The method of claim 2, further comprising modifying, by the processor, the assigned default values of the entity based on a meaning of the candidate trigger term when the entity is detected in the subtree originated at the identified node of the parse tree.

5. The method of claim 4, wherein the modification of the assigned default values of the entity based on the meaning of the candidate trigger term comprises:
determining, by the processor, modified values to be assigned to the entity from a plurality of modified values based on the meaning of the candidate trigger term; and
assigning, by the processor, the modified values to the entity.

6. The method of claim 5, wherein the plurality of modified values indicates whether the entity associated with the candidate is to be tagged as excluded or to be tagged as suspected, and whether the entity associated with the candidate is to be tagged with numerical based values or rule-based values.

7. The method of claim 5, wherein the annotating of the context of the entity is based on the modified values of the entity.

8. The method of claim 2, wherein, when the entity is not detected in the subtree originated at the identified node of the parse tree post executing the search for the entity, the method further comprises:
identifying, by the processor, a next node with a specific syntactic function associated with a next candidate trigger term in the parse tree;
executing, by the processor, a search for the entity in a subtree originated at the next identified node of the parse tree;
modifying, by the processor, the assigned default values of the entity based on meaning of the next candidate trigger term when the entity is detected in the subtree originated at the next identified node of the parse tree; and
annotating, by the processor, the context of the entity based on modified values of the entity.

9. The method of claim 1, wherein the extracting of the entity and the one or more trigger terms associated with the entity comprises executing, by the processor, an entity recognition tool to recognize the entity, and identifying, by the processor, the one or more trigger terms associated with the entity.

10. The method of claim 1, wherein the identifying of the node with the specific syntactic function associated with the candidate trigger term in the parse tree comprises:
executing, by the processor, a search along the parse tree to obtain the candidate trigger term; and
traversing, by the processor, the one or more nodes of the parse tree in a defined direction from the candidate trigger term to obtain the node with the specific syntactic function associated with the candidate trigger term.

11. The method of claim 5, further comprising:
executing, by the processor, a search in the subtree originated at the identified node of the parse tree to obtain a nested trigger term; and
re-modifying, by the processor, the modified values of the entity to the default values of the entity based on a presence of the nested trigger term in the subtree originated at the identified node of the parse tree.

12. The method of claim 1, further comprising:
utilizing, by the processor, the annotated context of the entity to establish eligibility or ineligibility of a candidate with the candidate identifier for a given clinical trial in accordance with eligibility criteria of the given clinical trial, and
forming, by the processor, an eligible candidate database of one or more candidates which are eligible for the given clinical trial in accordance with the eligibility criteria of the given clinical trials based on the annotated context of the entity retrieved from the one or more data items associated with a plurality of candidate identifiers.

13. The method of claim 1, further comprising:
receiving, by the processor, a user input of one or more words in a search portal; and
retrieving, by the processor, the candidate identifier having the one or more data items related to the one or more words based on the annotated context of the entity retrieved from the one or more data items.

14. A system for electronically determining semantic relationship in one or more data items, the system comprising:
a memory comprising the one or more data items; and
a processor communicatively coupled to the memory, wherein the processor is configured to:
extract an entity and one or more trigger terms associated with the entity from at least one sentence in the one or more data items, wherein the one or more data items are associated with a candidate identifier;
parse the at least one sentence in the one or more data items to generate a parse tree;
identify a node with a specific syntactic function associated with a candidate trigger term of the one or more trigger terms in the parse tree, wherein the identified node with the specific syntactic function comprises each element of the candidate trigger term;
execute a search for the entity in a subtree originated at the identified node of the parse tree; and
annotate context of the entity based on a presence of the entity in the subtree originated at the identified node of the parse tree, wherein the annotated context of the entity is used for determining semantic relationship in the data items to enable context-based search.

15. The system of claim 14, wherein the processor is further configured to assign a default value to the entity from a predefined set of default values post extraction of the entity based on one or more relational properties of the entity, and wherein the one or more relational properties of the entity comprises an addendum property and a temporality property.

16. The system of claim 15, wherein the processor is further configured to modify the assigned default value of the entity based on a meaning of the candidate trigger term when the entity is detected in the subtree originated at the identified node of the parse tree.

17. The system of claim 16, wherein the modification of the assigned default value of the entity based on the meaning of the candidate trigger term comprises:
determining modified values to be assigned to the entity from a plurality of modified values based on the meaning of the candidate trigger term; and
assigning the modified values to the entity.

18. The system of claim 16, wherein the processor is further configured to:
execute a search in the subtree originated at the identified node of the parse tree to obtain a nested trigger term; and
re-modify, the modified values of the entity to the default value of the entity based on a presence of the nested trigger term in the subtree originated at the identified node of the parse tree.

19. The system of claim 14, wherein the processor is further configured to:
utilize the annotated context of the entity to establish eligibility or ineligibility of a candidate with the candidate identifier for a given clinical trial in accordance with eligibility criteria of the given clinical trial, and
form an eligible candidate database (ECD) of one or more eligible candidates which are eligible for the given clinical trial in accordance with the eligibility criteria of the given clinical trial based on the annotated context of the entity retrieved from the one or more data items associated with a plurality of candidate identifiers.

20. The system according to claim 14, wherein the processor is further configured to:
receive a user input of one or more words in a search portal; and
retrieve the candidate identifier having the one or more data items related to the one or more words based on the annotated context of the entity retrieved from the one or more data items.
